(19) United States
(12) Patent Application Publication
(10) Pub. No.: US 2012/0159211 A1
(43) Pub. Date: Jun. 21, 2012

(54) APPARATUS AND METHOD FOR MANAGING POWER EQUIPMENT IN ADVANCED METERING INFRASTRUCTURE NETWORK

(75) Inventors: Hyun Hak KIM, Daejeon (KR); Tae Wook Heo, Daejeon (KR); Jong Arm Jun, Daejeon (KR)

(73) Assignee: ELECTRONICS AND TELECOMMUNICATIONS RESEARCH INSTITUTE, Daejeon (KR)

(21) Appl. No.: 13/316,929

(22) Filed: Dec. 12, 2011

(30) Foreign Application Priority Data
Dec. 15, 2010 (KR) 10-2010-0128076

(51) Int. Cl. G06F 1/32

(52) U.S. Cl. 713/320

(57) ABSTRACT

Provided is an apparatus and method for managing a power equipment in an advanced metering infrastructure (AMI) network included in a smart grid network. According to an aspect of the present invention, an apparatus and method for managing a power equipment in an AMI network may provide a load control environment enabling a power equipment to declare an opt-out when another power equipment declares an opt-out by providing a list of power equipments included in a load control group in response to a power equipment declaring an opt-out of the load control group so as to process an opt-out of a power equipment selected from the list.

### CROSS-REFERENCE TO RELATED APPLICATION

This application claims the benefit of Korean Patent Application No. 10-2010-0128076, filed on Dec. 15, 2010, in the Korean Intellectual Property Office, the disclosure of which is incorporated herein by reference.

### BACKGROUND

1. Field of the Invention

The present invention relates to an apparatus and method for managing power equipment in an advanced metering infrastructure (AMI) network included in a smart grid network.

2. Description of the Related Art

A power network may include a power provider for generating and providing power and a consumer provided with power from the power provider. The power provider may have a power contract with the consumer, and may charge the consumer fees depending on an amount of power used by the consumer, in accordance with the power contract.

The amount of power used by the consumer may be measured by means of a meter installed on premises of the consumer. Conventionally, an employee of the power provider reads the amount of power uses directly from the meter. Nowadays, progress of technology allows the employee of the power provider to collect, through an automatic meter reading (AMR), the amount of power used from the meter installed on the premises of the consumer.

Recently, an advanced metering infrastructure (AMI) network commands attention as state-of-the-art technology provides consumers with a pricing service, a demand response & load control (DRLC) service, a messaging service, a billing service, a distributed energy resource control (DERC) service in addition to a metering service of reading an amount of power used from a meter.

AMI network technology is defined as a smart energy profile (SEP) corresponding to a standard profile of the ZigBee Alliance. An energy services interface (ESI) connecting a power provider and a consumer via a network, an in-premise display (IPD) or an in-home display (IHD) expressing an AMI service on premises, a smart thermostat for adjusting temperature, a load control (LC) for controlling an amount of power use, a meter for collecting an amount of power use, a plug-in electric vehicle, a smart appliance, a prepayment terminal, a home energy management system (HEMS), and the like are defined in the AMI network. Further additions to AMI network are expected to be made.

According to a scheme defined in a current SEP, an LC device appointed by a DRLC protocol may receive a DRCL event from an energy service interface, and may process the DRCL event. A consumer desiring to suspend the DRCL event that is being processed in the LC device may press an opt-out button to command the LC device to opt out of the DRCL event. At that time, the LC device may report the energy service interface that the process of the DRCL event is suspended.

Currently, a consumer may directly command a relatively small number of LC devices installed on premises of the consumer since a number of smart energy control devices having the SEP is relatively small. However, an advance in AMI technology may entail a relatively large number of smart energy control devices, and may be inconvenient for the consumer to manage the relatively large number of smart energy control devices.

Even though the inconvenience may not be an issue for private homes, a building or a factory may use AMI technology for resolving the inconvenience. A conventional scheme of processing the SEP may require changes when a technology is developed to install wireless and wired devices in light emitting diodes (LEDs) at relatively low prices to separately control the LEDs, technology related to an electric car is realized as power to be used for charging is provided outside of a house, and technology related to a smart appliance is released to perform direct SEP communication, by incorporating an SEP device rather than performing SEP communication with an ESI, instead of an electronic device being connected to an LC device attached to an outlet.

### SUMMARY

An aspect of the present invention provides an apparatus and method for managing power equipments in an advanced metering infrastructure (AMI) network that performs an opt-out process for a power equipment selected from a list of power equipments included in a load control group in response to the power equipment declaring an opt-out from the load control group.

Another aspect of the present invention also provides an apparatus and method for managing power equipments in an AMI network that uses attribute information of power equipments and processes an opt-out of a power equipment selected from a list of power equipments having matching attributes by providing the list to a consumer in response to a power equipment declaring an opt-out.

Still another aspect of the present invention also provides an apparatus and method for managing power equipments in an AMI network that determines whether to opt-out a power equipment corresponding to an object of a load control by requesting information from a consumer about whether a power equipment included in a load control group opts out of the load control group when a power equipment declares an opt-out in response to opt-out manipulation of the consumer.

Yet another aspect of the present invention also provides an apparatus and method for managing power equipments in an AMI network that sets a substitute equipment for a power equipment, and operates a substitute equipment for a power equipment declaring an opt-out in response to the declared opt-out of the power equipment.

Further another aspect of the present invention also provides an apparatus and method for managing power equipments in an AMI network that adjusts an order of priority for a power equipment declaring an opt-out, and requests information from a power equipment having a relatively higher order of priority about whether the power equipment opts out or whether the power equipment operates as a substitute in response to a declared opt-out.

Still another aspect of the present invention also provides an apparatus and method for managing power equipments in an AMI network that handles an erroneously declared opt-out by delaying an opt-out in response to a power equipment declaring the opt-out.

According to an aspect of the present invention, there is provided an apparatus for managing power equipments in an AMI network, the apparatus including an opt-out declaring unit to declare an opt-out of a first power equipment from a load control group in response to an input of consumer manipulation, and an opt-out processing unit to process the declared opt-out by providing, to a consumer, a list of power equipments included in the load control group in response to the declared opt-out, in the opt-out declaring unit.

According to another aspect of the present invention, there is provided a method of managing power equipments in an AMI network, the method including declaring an opt-out of a first power equipment from a load control group in response to an input of consumer manipulation, providing, to a consumer, a list of power equipments included in the load control group in response to the declared opt-out, and processing an opt-out of a power equipment selected from the list.

According to an embodiment of the present invention, it is possible to provide a load control environment enabling a power equipment to declare an opt-out when another power equipment declares an opt-out by providing a list of power equipments included in a load control group in response to a power equipment declaring an opt-out of the load control group so as to process an opt-out of a power equipment selected from the list.

According to another embodiment of the present invention, it is possible to process an opt-out of a power equipment having an attribute matching an attribute of a power equipment declaring an opt-out concurrently with the declared opt-out. To achieve this, an apparatus and method of the present invention may use attribute information of power equipments and process an opt-out of a power equipment selected from a list of power equipments having matching attributes by providing the list to a consumer in response to a power equipment declaring an opt-out.

According to still another embodiment of the present invention, it is possible to actively handle opt-out manipulation as instructed by a consumer by determining whether to opt out a power equipment corresponding to an object of a load control by requesting information from the consumer about whether a power equipment included in a load control group opts out of the load control group when a power equipment declares an opt-out in response to opt-out manipulation of the consumer.

According to yet another embodiment of the present invention, it is possible to smoothly organize a load control group by operating a power equipment substituting for a power equipment declaring an opt-out. To achieve this, an apparatus and method of the present invention may set a substitute equipment for a power equipment, and operate the substitute equipment for a power equipment declaring an opt-out in response to the declared opt-out of the power equipment.

According to further another embodiment of the present invention, it is possible to promptly determine whether a power equipment opts out or whether a power equipment operates as a substitute by adjusting an order of priority for a power equipment declaring an opt-out, and requesting information from a power equipment having a relatively higher order of priority about whether the power equipment opts out or whether the power equipment operates as a substitute in response to a declared opt-out.

According to still another embodiment of the present invention, it is possible to reliably process a declared opt-out of a power equipment by delaying an opt-out in response to a power equipment declaring the opt-out so as to handle an erroneously declared opt-out.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a power equipment according to an embodiment of the present invention;

FIG. 2 is a diagram illustrating a load control event (LCE) provider and a plurality of load control (LC) devices processing an opt-out event according to another embodiment of the present invention;

FIG. 3 is a diagram illustrating an LCE provider and a plurality of LC devices exchanging attribute information according to still another embodiment of the present invention;

FIG. 4 is a diagram illustrating an LCE provider and a plurality of LC devices processing an opt-in event according to yet another embodiment of the present invention;

FIG. 5 is a diagram illustrating performing an opt-out or an opt-in before a start randomization period according to further another embodiment of the present invention; and

FIG. 6 is a diagram illustrating performing an opt-out or an opt-in within a start randomization period according to still another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

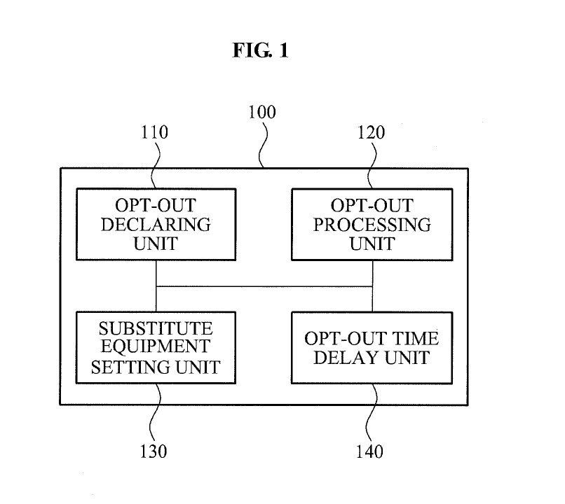

FIG. 1 is a block diagram illustrating a power equipment according to an embodiment of the present invention.

A power equipment 100 may include an opt-out declaring unit 110 to declare an opt-out of a first power equipment from a load control group in response to an input of consumer manipulation, and an opt-out processing unit 120 to process the declared opt-out by providing, to a consumer, a list of power equipments included in the load control group in response to the declared opt-out, in the opt-out declaring unit 110.

The load control group may use attribute information of the power equipment 100, and the opt-out processing unit 120 may provide, to a consumer, a list of power equipments having matching attributes associated with attribute information of the power equipment 100.

The opt-out processing unit 120 may request information from a power equipment, other than the power equipment 100 declaring an opt-out, included in the load control group about whether the power equipment opts out of the load control group.

A substitute equipment setting unit 130 may set a second power equipment as a substitute equipment for the first power equipment. The opt-out declaring unit 120 may operate the second power equipment associated with the declared opt-out of the first power equipment.

The opt-out declaring unit 120 may adjust an order of priority for the second power equipment, and request information from a power equipment, other than the first power equipment and the second power equipment, included in the load control group about whether the power equipment opts out of the load control group or whether the power equipment operates as a substitute.

An opt-out time delay unit 140 may delay an opt-out of a power equipment declaring the opt-out to provide the power equipment with a further chance of opting in the load control group.

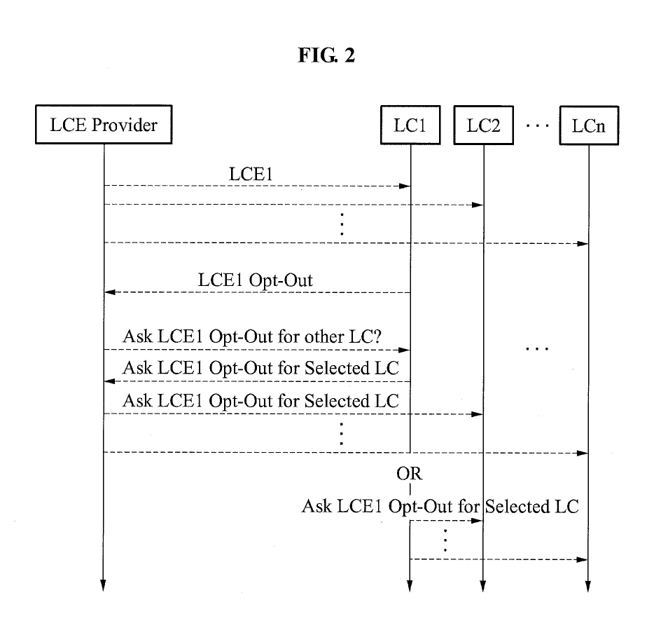

FIG. 2 is a diagram illustrating a load control event (LCE) provider and a plurality of load control (LC) devices processing an opt-out event according to an embodiment of the present invention.

An LCE provider and an LC device may be included in a power equipment.

A device, for example, an energy services interface (ESI), a home energy management system (HEMS), and an in-premise display (IPD) that may send an LCE may be used as the LCE provider.

The LCE provider may transmit an LCE to n LC devices of which names are LC1, LC2, . . . , LCn. Thereafter, a consumer may opt out an LC device, for example, LC1 of the LCE. In this instance, when the consumer conventionally desires to opt out other LC devices, for example, LC2, LC3, and LC4, the consumer may visit the LC devices, for example, LC2, LC3, and LC4 and command an opt-out by pressing an opt-out button.

However, according to an embodiment of the present invention, the LCE provider or the LC device may verify whether the consumer desires a concurrent opt-out. That is, when the consumer desires a concurrent opt-out, the LCE provider or the LC1 may request an opt-out of LC devices, for example, LC2, LC3, and LC4 designated through the LCE provider or the LC1.

For example, when the LCE provider receives a request for an opt-out from an LCE, the LCE provider or the LC device may display candidates for an LC device that is prepared in advance and to be operated.

Each LC device may include UtilityEnrolmentGroup (UEG) and DeviceClassValue (DCV) attributes defined in a smart energy profile (SEP), as shown in Table 1 below.

TABLE 1
Demand Response Client Cluster Attributes

| | | | | | | Mandatory/ |
|---|---|---|---|---|---|---|
| Identifier | Name | Type | Range | Access | Default | Optional |
| 0x0000 | UtilityEnrolmentGroup | Unsigned | 0x00 to 0xFF | Read/ | 0x00 | M |
| | | 8 bit | | Write | | |
| | | Integer | | | | |
| 0x0001 | StartRandomizeMinutes | Unsigned | 0x00 to 0x3C | Read/ | 0x1E | M |
| | | 8 bit | | Write | | |
| | | Integer | | | | |
| 0x0002 | StopRandomizeMinutes | Unsigned | 0x00 to 0x3C | Read/ | 0x1E | M |
| | | 8 bit | | Write | | |
| | | Integer | | | | |
| 0x0003 | DeviceClassValue | Unsigned | 0x00 to 0xFF | Read | — | M |
| | | 16 bit | | | | |
| | | Integer | | | | |
| 0x0004 to 0xFFFF | Reserved | | | | | |

The device classes illustrated in Table 1 are shown in Table 2 below.

TABLE 2
Device Class Field BitMap/Encoding

| Bit | Description |
|---|---|
| 0 | HVAC compressor or furnace |
| 1 | Strip Heaters/Baseboard Heaters |
| 2 | Water Heater |
| 3 | Pool Pump/Spa/Jacuzzi |
| 4 | Smart Appliances |
| 5 | Irrigation Pump |
| 6 | Managed Commercial & Industrial (C&I) loads |
| 7 | Simple misc. (Residential On/Off) loads |
| 8 | Exterior Lighting |
| 9 | Interior Lighting |
| 10 | Electric Vehicle |
| 11 | Generation Systems |
| 12 to 15 | Reserved |

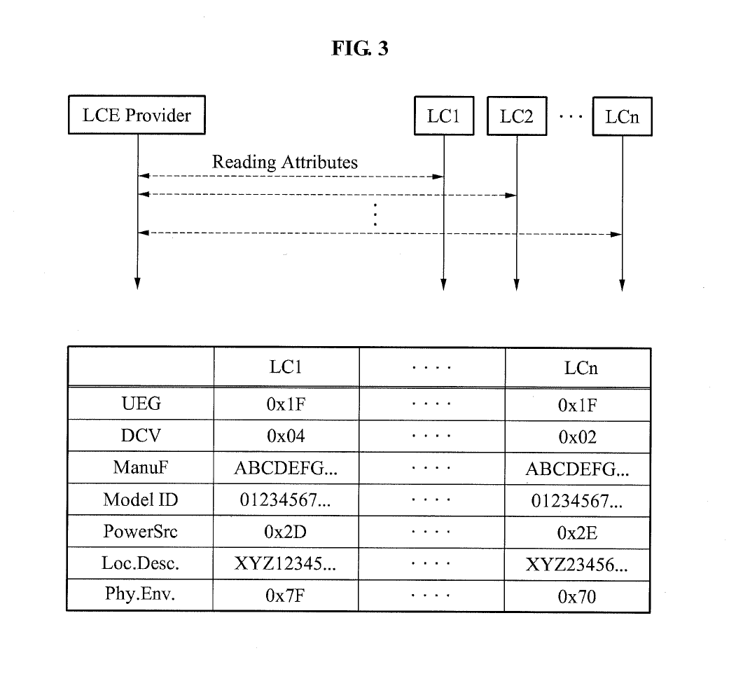

FIG. 3 is a diagram illustrating an LCE provider and a plurality of LC devices exchanging attribute information according to an embodiment of the present invention.

A smart energy device may include Basic Cluster (Cluster ID:0x0000) as a mandatory item and attributes such as Manufacturer Name, Model ID, Power Source, Location Description, and Physical Environment.

The LCE provider or an LC device may select candidates for a device desired to be operated together, and request information from a consumer. For example, when an LC device opts out of a load control group, other devices similar to the LC device or located near the LC device may be selected as the candidates.

Premises of a consumer may include a single HEMS or a single IPD. A case in which a consumer opts out an LC device of an LCE may correspond to an exceptional case and thus, the consumer may be likely to be near the LC device to command an opt-out rather than accessing the HEMS or IPD. Further, the HEMS and IPD may not be installed or may be normally turned off to reduce power since the HEMS and IPD may be turned on continually. An effective scheme may be commanding an opt-out of devices desired to be opted out concurrently with an LC device in an instance of the exceptional case in which a consumer desires to opt out the LC device of a load control group. Additionally, the LC device may automatically suggest the candidates using the attribute information.

When premises of a consumer have a system such as an HEMS and an IPD, a consumer may select the candidates in advance. For example, when a group to which the LC device belongs is set to a “lowest priority energy conservation group 1” and the LC device opts out of the group, the system may request information from the consumer about whether devices in the lowest priority energy conservation group are concurrently opting out of the group.

For example, when an LC device opts out, an operation set of several devices may be set in advance and be executed after the LC devices opts out. That is, when an LC device LC1 opts out, an operation set is commanded to be set so that a substitute device LC5 of the LC device LC1 operates and an operation set is commanded to be set so that substitute devices LC 6, 7, and 8 of LC devices 2, 3, and 4 that opt out operate.

As described in the foregoing, since a consumer may repeat a selection of devices to be opted out or a selection of an operation set, an LC device may request information from the consumer about a candidate when a subsequent opt-out command occurs.

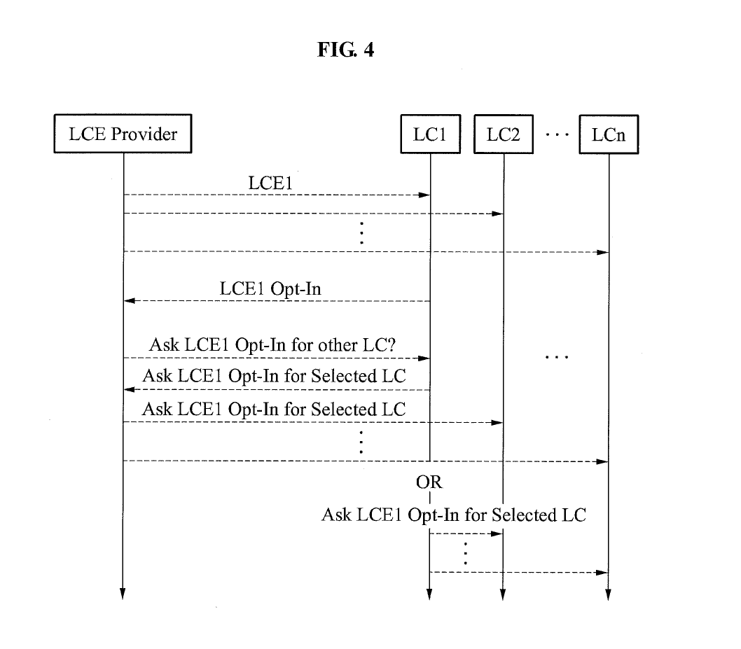

FIG. 4 is a diagram illustrating an LCE provider and a plurality of LC devices processing an opt-in event according to an embodiment of the present invention.

An example of an opt-out process has been described with reference to FIG. 2 to provide an example of a basic opt-in time of an LC device according to a type of an LCE and a power contract, thus a similar description will be omitted for conciseness. Here, since the LC device may not basically opt in according to a type of an LCE and a power contract, a scheme for an opt-out process may be applied to a case of an opt-in.

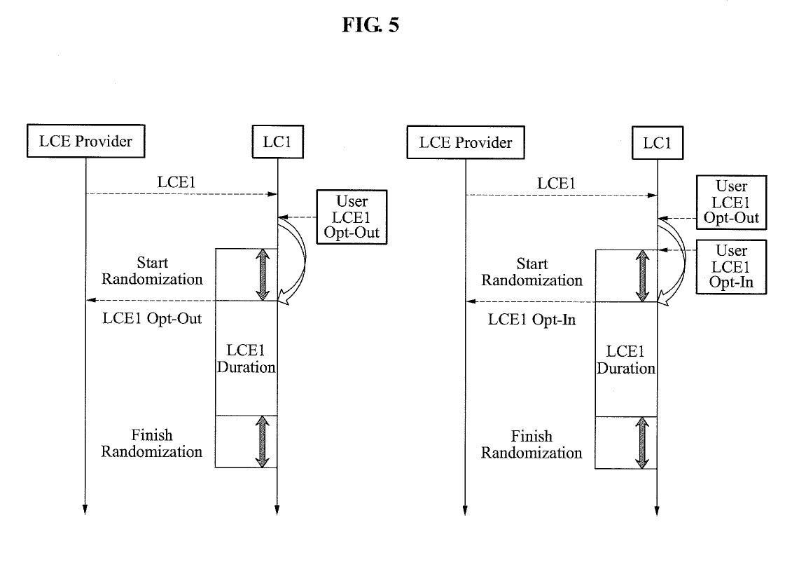

FIG. 5 is a diagram illustrating performing an opt-out or an opt-in before a start randomization period according to further another embodiment of the present invention.

As an example, when an LC device immediately reports an opt-out from an LCE to an LCE provider such as an ESI in response to the LC device being selected to be opted out of an LCE, the LC device may not opt in to the LCE again. Thus, the LC device may adjust (for example, delay) a starting time of the LCE within a range of which a subsequent LCE is not interfered, and leave a chance for a consumer to opt in before a permitted time period for starting the LCE by utilizing information about whether a randomization stated in the LCE is permitted and a maximum amount of a randomization time is permitted for the LC Device.

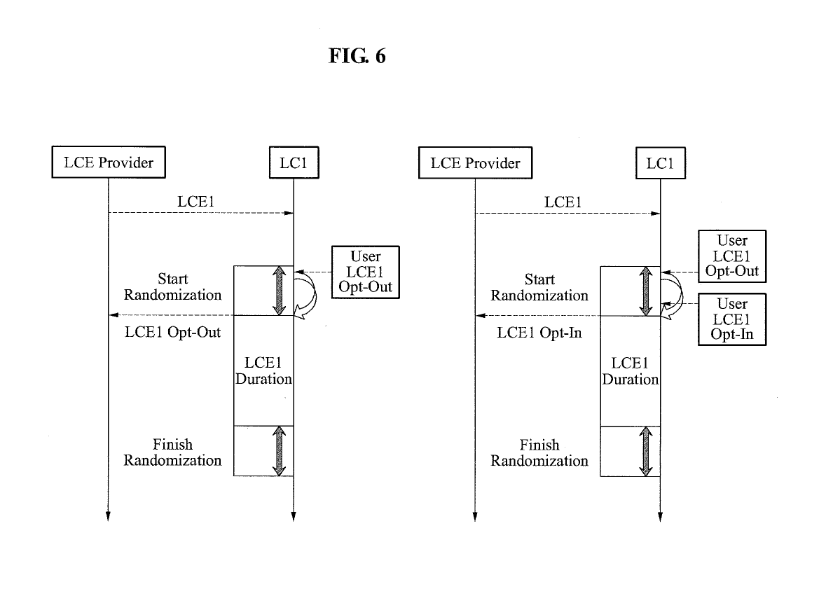

FIG. 6 is a diagram illustrating performing an opt-out or an opt-in within a start randomization period according to still another embodiment of the present invention.

Here, since determining whether to opt in to an LCE or opt out of the LCE may directly affect a discount based on a power contract, an effective method of managing an LCE may be used.

Methods and schemes described in the foregoing may be used for a control of a distributed energy resource in a distributed energy resource control (DERC) as well as for a control of an LCE. For example, a command desiring to reversely provide power to a power provider in a distributed energy resource of a consumer may have an opt-out that suspends a power supply and an opt-in that starts a power supply. As described in the foregoing, candidates for a distributed energy resource device to operate may be selected and displayed, or a subsequent operation set may be applied. Thus, an effective method of managing a distributed energy resource may be provided by utilizing a randomization period.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for managing power equipments in an advanced metering infrastructure (AMI) network, the apparatus comprising:
an opt-out declaring unit to declare an opt-out of a first power equipment from a load control group in response to an input of consumer manipulation; and
an opt-out processing unit to process the declared opt-out by providing, to a consumer, a list of power equipments included in the load control group in response to the declared opt-out, in the opt-out declaring unit.

2. The apparatus of claim 1, wherein:
the load control group uses attribute information of power equipments, and
the opt-out processing unit provides, to a consumer, a list of power equipments associated with attribute information of the first power equipment.

3. The apparatus of claim 1, wherein the opt-out processing unit requests information from a power equipment, other than the first power equipment, included in the load control group about whether the power equipment opts out of the load control group.

4. The apparatus of claim 1, further comprising:
a substitute equipment setting unit to set a second power equipment as a substitute equipment for the first power equipment,
wherein the opt-out declaring unit operates the second power equipment associated with the declared opt-out.

5. The apparatus of claim 4, wherein the opt-out processing unit
adjusts an order of priority for the second power equipment, and
requests information from a power equipment, other than the first power equipment and the second power equipment, included in the load control group about whether the power equipment opts out of the load control group or whether the power equipment operates as a substitute.

6. The apparatus of claim 1, further comprising:
an opt-out time delay unit to delay an opt-out of the first power equipment.

7. A method of managing power equipments in an advanced metering infrastructure (AMI) network, the method comprising:
declaring an opt-out of a first power equipment from a load control group in response to an input of consumer manipulation;
providing, to a consumer, a list of power equipments included in the load control group in response to the declared opt-out; and
processing an opt-out of a power equipment selected from the list.

8. The method of claim 7, further comprising:
using attribute information of power equipments in the load control group; and
providing, to a consumer, a list of power equipments having matching attributes associated with the attribute information of power equipments.

9. The method of claim 7, further comprising:
requesting information from a power equipment, other than the first power equipment, included in the load control group about whether the power equipment opts out of the load control group.

10. The method of claim 7, further comprising:
setting a second power equipment as a substitute equipment for the first power equipment; and
operating the second power equipment associated with the declared opt-out.

11. The method of claim 10, further comprising:
adjusting an order of priority for the second power equipment; and
requesting information from the second power equipment having a relatively higher order of priority about whether the second power equipment opts out of the load control group or whether the second power equipment operates as a substitute.

12. The method of claim 7, further comprising:
delaying an opt-out of the first power equipment.
